(19) United States
(12) Patent Application Publication
(10) Pub. No.: US 2010/0230903 A1
(43) Pub. Date: Sep. 16, 2010

(54) SEALING APPARATUS

(75) Inventor: Shigeki Honda, Tokyo (JP)

Correspondence Address: HARNESS, DICKEY & PIERCE, P.L.C., P.O. BOX 828, BLOOMFIELD HILLS, MI, 48303, US

(73) Assignee: EAGLE INDUSTRY CO., LTD., Tokyo (JP)

(21) Appl. No.: 12/680,340

(22) PCT Filed: Jul. 3, 2009
(86) PCT No.: PCT/JP2009/062198

§ 371 Date: Mar. 26, 2010

(30) Foreign Application Priority Data
Jul. 7, 2008 (JP) 2008-176854

(51) Int. Cl. F16J 15/53

(52) U.S. Cl. 277/501

(57) ABSTRACT

The objective of the present invention is to provide a sealing apparatus having a simple structure and good sliding lifetime, and suitable to transfer a motion from an outside into the closed space such as a clean room or a chamber or so. The present invention is a sealing apparatus comprising a shaft transferring the mechanical motion, a housing through which the shaft penetrates, a magnetic force generating means generating a magnetic force, a pair of inner protruded edge forming a sealing groove by projecting toward the shaft from the housing, a magnetism transferring member transferring the magnetic force generated from the magnetic force generating means by provided adjacent to the magnetic force generating means, a sealing member sliding against the outer face of the shaft, and a magnetic fluid held between the shaft and the magnetism transferring member due to the magnetic force generated by the magnetic force generating means; wherein a fluid holding projection portion projecting out towards the shaft and the sealing member is formed at an end portion near by the shaft of a first inner protruded edge among said pair of the inner protruded edge adjacent to the magnetic force generating means.

### TECHNICAL FIELD

The present invention relates to a sealing apparatus suitable to transfer a motion into the closed space such as a clean room or a chamber or so from an outside.

### BACKGROUND ART

For example, a process of an oxidation, dispersion, or CVD (Chemical Vapor Deposition) or so to a semiconductor wafer during a production process of the semiconductor device are performed by maintaining the wafer in vacuo or in a particular gas atmosphere. In many cases, the wafer is placed in a chamber or container (hereinafter refer to as process chamber) held in a predetermined room, and is processed by exposing to the atmosphere of the process chamber by rotating or so. Thus, for the process chamber used for such process, it is required to have air tightness, and to be able to transfer the mechanical motion to the process chamber inner side from the outside thereof such as by rotating the wafer or so.

As for the prior art to transfer the mechanical motion into the process chamber while the process chamber is closed, for example, the sealing apparatus using an elastomer seal (O ring or so) in which vacuum grease is coated is known. However, in such prior art, the grease is held at an axis and a sliding portion of the seal, thus a viscosity of the used vacuum grease had to be high. Therefore, even when the grease is deteriorated, it did not replace with the surrounding grease, and thus shortened the sliding lifetime.

As for a prior art to solve such problems, for example the sealing apparatus using the magnetic fluid held between the elastomer seal and the pole piece and the axis by the magnetic force is known (refer to patent document 1). However, in such prior art, though the magnetic fluid can be held at the edge of the pole piece, most of the magnetic fluid cannot reach to the elastomer seal. Hence, the magnetic fluid used in the sealing apparatus of the prior art cannot sufficiently function as a lubricant. Thus the sealing apparatus of the prior art still had a problem of the sliding lifetime.

Also, as for the prior art relating to the sealing apparatus, the sealing apparatus comprising an axis having an ring form projection and a yoke contacting with a permanent magnet, and holding the magnetic fluid between the inner surface of the yoke and the ring form projections (rotational bearing for sealing magnetic fluid of projection type rotating axis) is known (refer to patent document 2). However, the sealing apparatus holding the magnetic fluid between the inner circumference of the yoke and the ring form projections has problems in productivity and cost performances; because the structure is complicated, and extremely accurate process steps and assembling steps are required.

### Patent Document

Patent document 1: JP-A H7-317916
Patent document 2: JP-A 2003-294156

### DISCLOSURE OF THE INVENTION

### Technical Problems to be Solved by the Invention

The present invention is achieved in view of such problems, and the objective of the present invention is to provide a sealing apparatus having a simple structure and good sliding lifetime, and suitable to transfer a motion into the process chamber from an outside.

### Means for Solving the Technical Problems

In order to achieve the above objection, the first aspect according to the present invention is a sealing apparatus transferring a predetermined mechanical motion to inside of a process chamber maintained at a predetermined environment from outside of the process chamber while maintaining the environment of the process chamber; wherein the sealing apparatus comprises,

a shaft transferring the predetermined mechanical motion to the process chamber,

a housing through which the shaft penetrates,

a magnetic force generating means generating a magnetic force around the shaft by provided between the housing and the shaft,

a magnetism transferring member having a pair of inner protruded edges forming a sealing groove surrounding the shaft by projecting toward the shaft from the housing, and transferring the magnetic force generated from the magnetic force generating means by provided adjacent to the magnetic force generating means,

a sealing member stored in the sealing grooves while at least part of the sealing member is projecting out towards the shaft and sliding against the outer face of the shaft, and

a magnetic fluid held between the shaft and the magnetism transferring member due to the magnetic force generated by the magnetic force generating means; wherein

a fluid holding projection portion projecting out towards the shaft and the sealing member is formed at an end portion near by the shaft of a first inner protruded edge, and said first inner protruded edge is one of said pair of the inner protruded edges adjacent to the magnetic force generating means.

In the sealing apparatus according to the first aspect of the present invention, the fluid holding projection portion is formed at the first inner protruded edge of the magnetism transferring member by projecting out towards the shaft and the sealing member. Therefore, the sliding face against the shaft in the sealing member is provided near by the fluid holding projection portion in which the magnetic fluid is held the most. Hence, the distance between the magnetic fluid held at the magnetism transferring member and the sealing member becomes shorter; thereby the magnetic fluid can easily reach to the sliding face of the sealing member. That is, in the sealing apparatus according to the present invention, the magnetic fluid suitably act as the lubricant near the sliding face between the shaft and the sealing member, and thus can elongate the sliding lifetime of the sealing member.

Also, the second aspect of the sealing apparatus according to the present invention is a magnetic fluid sealing apparatus transferring a predetermined mechanical motion to inside of a process chamber maintained at a predetermined environment from outside of the process chamber while maintaining the environment of the process chamber; wherein the sealing apparatus comprises,

a shaft transferring the predetermined mechanical motion to the process chamber,

a housing through which the shaft penetrates,

a magnetic force generating means generating a magnetic force around the shaft by provided between the housing and the shaft,

a magnetism transferring member having a pair of inner protruded edges forming a sealing groove surrounding the shaft by projecting toward the shaft from the housing, and transferring the magnetic force generated from the magnetic force generating means by provided adjacent to the magnetic force generating means,

a sealing member stored in the sealing grooves while at least part of the sealing member is projecting out towards the shaft and sliding against the outer face of the shaft, and

a magnetic fluid held between the shaft and the magnetism transferring member due to the magnetic force generated by the magnetic force generating means; wherein

the sealing grooves having a dovetail groove form.

In the sealing apparatus according to the second aspect of the present invention, the sealing member is placed in the sealing grooves having the dovetail groove form. Thus, the sliding face against the shaft at the sealing member is provided near by the edge portion of the magnetism transferring member in which lots of magnetic fluid is held. Hence, the distance between the magnetic fluid held at the magnetism transferring member and the sealing member becomes shorter; thereby the magnetic fluid can easily reach to the sliding face of the sealing member. That is, in the sealing apparatus according to the present invention, the magnetic fluid suitably acts as the lubricant near the sliding face between the shaft and the sealing member, and thus can elongate the sliding lifetime of the sealing member.

Also, the sealing apparatus according to the third aspect of the present invention is a magnetic fluid sealing apparatus transferring a predetermined mechanical motion to inside of a process chamber maintained at a predetermined environment from outside of the process chamber while maintaining the environment of the process chamber; wherein the sealing apparatus comprises,

a shaft transferring the predetermined mechanical motion to the process chamber,

a housing through which the shaft penetrates,

a magnetic force generating means generating a magnetic force around the shaft by provided between the housing and the shaft,

a magnetism transferring member having a pair of inner protruded edges forming a sealing groove surrounding the shaft by projecting toward the shaft from the housing, and transferring the magnetic force generated from the magnetic force generating means by provided adjacent to the magnetic force generating means,

a sealing member stored in the sealing grooves while at least part of the sealing member is projecting out towards the shaft and sliding against the outer face of the shaft, and

a magnetic fluid held between the shaft and the magnetism transferring member due to the magnetic force generated by the magnetic force generating means; wherein

a cross section of the sealing grooves observed from the cross section passing through a center axis of the shaft has roughly a square form,

the sealing member comprises four projection portions projecting out towards each of corners of the sealing grooves having roughly a square form, and

a fluid holding groove configured to hold the magnetic fluid is formed between two projection portions projecting out towards the shaft side among the projection portions.

In the sealing apparatus according to the third aspect of the present invention, the sealing member having the projection portions projecting out towards each of corners of the square form is placed in the sealing grooves having roughly a square cross section form. Thus, the two projection portions constituting the sliding face against the shaft by projecting out towards the shaft sides are provided near by the edge portion of the magnetism transferring portion in which lots of magnetic fluid is held. Hence, the distance between the magnetic fluid held by the magnetic transferring member and the sealing member becomes shorter; thereby the magnetic fluid can easily reach to the sliding face of the sealing member. That is, in the sealing apparatus according to the present invention, the magnetic fluid suitably acts as the lubricant near the sliding face between the shaft and the sealing member, and thus can elongate the sliding lifetime of the sealing member.

Also, for example, the sealing apparatus according to the present invention may comprise a second magnetism transferring member provided to sandwich the magnetic force generating means with respect to the magnetism transferring member to transfer the magnetism generated by the magnetic force generating means. By comprising the second magnetism transferring member provided to sandwich the magnetic force generating means with respect to the magnetism transferring member, the sealing apparatus of the present invention further assures to hold the magnetic fluid at the edge portion near by the shaft in the magnetism transferring member.

### BRIEF DESCRIPTION OF DRAWINGS

FIG. 1 is a cross section of a sealing apparatus according to the first embodiment of the present invention.

FIG. 2 is a cross section of a sealing apparatus according to the second embodiment of the present invention.

FIG. 3(a) is an enlarged cross section of a first magnetic pole portion and FIG. 3(b), FIG. 3(c) are the modified example thereof provided to the sealing apparatus according to one embodiment of the present invention.

FIG. 4 is an enlarged cross section of the first magnetic pole provided to the sealing apparatus used in a reference example 3 of the present invention.

FIG. 5 is a cross section of the sealing apparatus according to the third embodiment of the present invention.

### BEST MODE FOR CARRYING OUT THE INVENTION

### First Embodiment

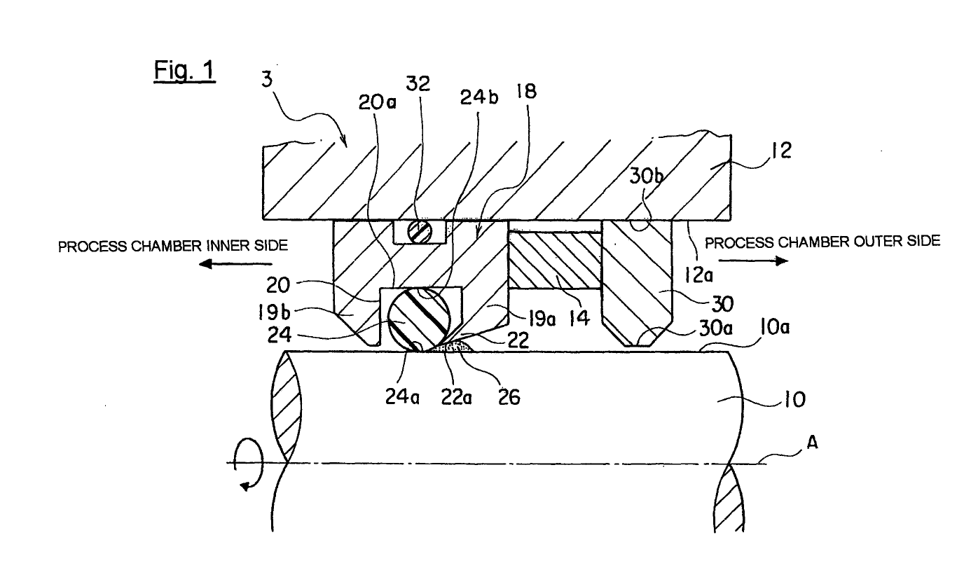

FIG. 1 is a cross section of a sealing apparatus 3 according to the first embodiment of the present invention. The sealing apparatus 3 is provided so that it covers the opening provided at the process chamber which is not shown in the figure, and thus inside of the process chamber can be maintained in vacuo compared to the outside of the process chamber. The process chamber in which the sealing apparatus 3 according to the present embodiment is provided is not particularly limited, and for example, a wafer process chamber for processing a silicon wafer, or a load lock chamber for repeating the in vacuo status and the atmospheric status, or so may be mentioned. Also, the inside of the process chamber may be maintained at a negative pressure environment compared to the outside of the process chamber, or it may be maintained under isotactic or pressurized environment.

The sealing apparatus 3 comprises a housing 12, a shaft 10, a magnet 14 as a magnetic force generating means, a first and second magnetic pole member 18 and 30 as a magnetism transferring member, an O ring 24 as a sealing member, and a magnetic fluid 26. The shaft 10 is provided so that it penetrates through the housing 12 having a tubular form. Note that, the magnet 14 and the first magnetic pole member 18 may be formed as one unit. Alternatively, the magnet 14 may be a part of the first magnetic pole member; for example, the portion fixing the magnetic fluid 26 (a first inner protruded edges 19a) in the first magnetic pole member 18 may be the magnetic force generating means.

The end portion of the shaft 10 at the process chamber outer side is connected to a driving portion which is not shown in the figure. The shaft 10 according to the present embodiment can rotate taking the axis A as a center due to the driving force of the driving portion. The end portion of the shaft 10 at the process chamber inner side is connected to a driven portion, which is not shown in the figure, and is provided inside of the process chamber. Thereby the shaft 10 according to the present embodiment can transfer the rotation motion generated by the driving portion provided outside of the process chamber to process chamber inner side. Note that, although the shaft 10 is formed by using a magnetic material, the entire body of the shaft is not limited to be made from a solid magnetic material. For example, the shaft may be formed by; an austenite steel equipping with a sleeve made of the magnetic material on the surface, non-ion material, or a non-magnetic material such as quartz or so; alternatively, it may be a sleeve alone. Also, it is possible to coat a resin on the surface of the shaft formed by using the magnetic material for the sliding property or preventing the rust or so. The thickness of the coating may be the thickness which does not overly weaken the magnetic force line from the magnetic material.

The housing 12 is a cylindrical member provided so that the shaft 10 penetrate through, and fixed to the process chamber which is not shown in the figure. Between an inner circumference 12a of the housing 12 and an outer circumference 10a of the shaft 10, a predetermined space is provided so that the magnet 14, the first magnetic pole member 18, a second magnetic pole member 30, and the O ring 24 or so can be provided.

At the space between the inner circumference 12a of the housing 12 and the outer circumference 10a of the shaft 10, the second magnetic pole member 30, the magnet 14, and the first magnetic pole member 18 are provided along the axis A direction of the shaft 10. The magnet 14 having a ring form is the magnetic force generating means generating the magnetism to hold the magnetic fluid 26, as described in the following; and is provided between the first magnetic pole member 18 and the second magnetic pole member 30, in the axis A direction. Note that, the form of the magnet 14 is not particularly limited to the ring form such as the present embodiment, and for example, it may be a cylindrical form magnets arranged in a ring form aligning the axis directions so that it surrounds the shaft 10.

At the end portion of the magnet 14 at the process chamber outer side, the second magnetic pole member 30 having a ring form is connected. The second magnetic pole member 30 is a magnetic material provided so that it contacts to the magnet 14. The second inner circumference end portion 30a which is an inner circumference end portion of the second magnetic member 30 is provided so that a slight space is left against the outer circumference 10a of the shaft 10. Also, a second outer circumference end portion 30b of the second magnetic pole member 30 may be fixed to an inner circumference 12a of the housing 12.

At the end portion of the magnet 14 at the process chamber inner side, the first magnetic pole member 18 having a ring form is connected. The first magnetic pole member 18 is a magnetic material provided so that it contacts to the magnet 14, as similar to the second magnetic pole member 30. The first outer circumference end portion 18b of the first magnetic pole member 18 is fixed to the inner circumference 12a of the housing 12. At the space between the first magnetic pole member 18 and the housing 12, a static sealing member 32 for sealing the first outer circumference end portion 18b of the first magnetic pole member 18 and the inner circumference 12a of the housing 12 may be provided.

The first magnetic pole member 18 comprises the first inner protruded edge 19a and the second inner protruded edge 19b projecting out towards the outer circumference 10a side of the shaft 10 from the inner circumference 12a side of the housing 12. The first inner protruded edge 19a is formed at the process chamber outer side compared to the second inner protruded edge 19b. Hence, the first inner protruded edge 19a is provided near by the magnet 14 than the second inner protruded edge 19b.

At the edge portion of the first inner protruded edge 19a towards the side close to the shaft 10, the fluid holding projection 22 is formed which projects towards the shaft 10 and the O ring 24. The fluid holding projection portion 22 is provided so that a slight space is formed between the outer circumference 10a of the shaft 10. The magnetic fluid 26 is held near the edge portion 22a of the fluid holding projection 22 by the magnetic force generated by the magnet 14.

At the space between the first inner protruded edge 19a and the second inner protruded edge 19b, the sealing groove 20 is formed. The sealing groove 20 is formed so that it surrounds the shaft 10, and comprises the opening at the outer circumference 10a side of the shaft 10.

The O ring 24 having a ring form is placed in the sealing groove 20. The O ring according to the present embodiment has a cross section of roughly a circular or oval form when observed from the cross section passing the axis A of the shaft 10. Also, a part of the O ring 24 is placed in the sealing groove 20 while sticking out therefrom.

The ring outer circumference end portion 24b of the O ring 24 contacts with the base portion 20a of the sealing groove 20; and the base portion 20a of the sealing groove 20 and the O ring 24 are closely and continuously contacted in the circumferential direction.

Also, the O ring 24 slightly contacts with the shaft 10; and is designed so that the contact torque does not become excessively large and satisfies the sealing property. In the sealing apparatus 3 according to the present embodiment, the O ring 24 is placed in the sealing groove 20 while slightly pressed in the radial direction of the axis A by the base portion 20a of the sealing groove 20 and the outer circumference 10a of the shaft 10. Note that, the O ring 24 is preferably made of a material having a suitable elasticity for instance such as elastomer or so.

When the shaft 10 rotates taking the axis A as a center, the ring inner circumference end portion 24a of the O ring 24 will slide against the outer circumference 10a of the shaft 10. Therefore, the O ring 24 according to the first embodiment can seal the space between the first magnetic pole member 18 and the shaft 10.

The magnetic fluid 26 is held near by the edge portion 22a of the fluid holding projection portion 22. The magnetic fluid 26 used in the present embodiment is made by dispersing the magnetic ultra fine particles having the particle diameter of 5˜50 nm or so in the solvent or oil (base oil) using a surfactant; and has a property being trapped in the magnetic field by moving along the magnetic force line. In the sealing apparatus 3 of the present embodiment, the magnetic fluid 26 is used as the lubricant acting at the sliding face between the shaft 10 and the O ring 24; and elongates the sliding lifetime of the O ring 24. Also, the magnetic fluid 26 assures the sealability at the sliding face between the O ring 24 and the shaft 10, and also prevents the dust emission near the sliding face.

When the shaft 10 rotates taking the axis A as the center, the magnetic fluid 26 held near by the edge portion 22a of the fluid holding projection portion 22 reaches to the sliding face between the shaft 10 and the O ring 24 thereby the magnetic fluid 26 acts as the lubricant. Particularly, in the sealing apparatus 3 according to the present embodiment, the fluid holding projection portion projects out towards the O ring 24 and the shaft 10, thus the edge portion 22a of the fluid holding projection portion 22 holding the magnetic fluid the most is provided so that it closely near by the O ring 24. Therefore, the magnetic fluid 26 can easily reach to the sliding face between the shaft 10 and the O ring 24 via the O ring 24.

Also, as shown in FIG. 1, since the O ring 24 has a cross section of roughly a circular or oval form, the ring inner circumference end portion 24a as the sliding face at the O ring 24 is provided near by the edge portion 22a of the fluid holding projection portion 22. Therefore, from this point of view, the magnetic fluid 26 held around the edge portion 22a of the magnetic holding projection 22 can easily reach to the sliding face between the shaft 10 and the O ring 24, and suitably acts as the lubricant.

Note that the fluid holding projection portion 22 is preferably formed at the first inner protruded edge 19a near by the magnet 14 among the two inner protruded edges 19a and 19b. More magnetic flux passes through the first inner protruded edge 19a near by the magnet 14, compared to the second protruded edge 19b. Therefore, by forming the fluid holding projection portion 22 at the first inner protruded edge 19a, further more magnetic fluid 26 can be held at the fluid holding projection portion 22.

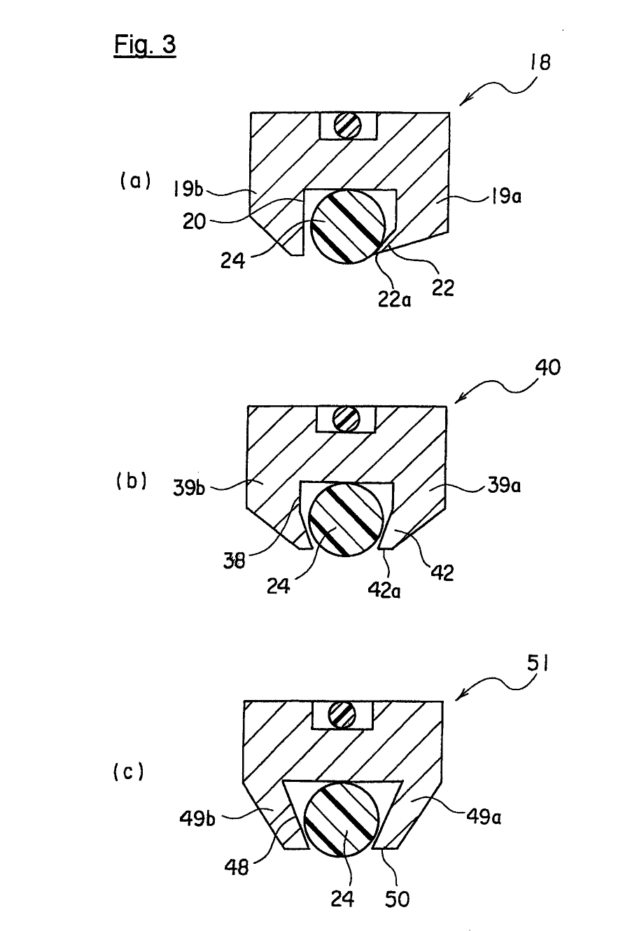

As shown in FIG. 3(a), the sealing groove 20 formed at the first magnetic pole member 18 has a dovetail groove form. The first inner protruded edge 19a constitute a part of the wall of the sealing groove 20, and the fluid holding projection portion 22 formed at the edge portion of the first inner protruded edge 19a is tilted towards the sealing groove 20. Also, in the sealing apparatus 3 according to the first embodiment, the O ring 24 comprising a cross sectional shape of roughly a circular or oval form when observed from the cross section passing through the axis A of the shaft 10 is placed in the sealing groove 20 having a dovetail groove form. Therefore, the edge portion 22a of the fluid holding projection portion 22 in which the magnetic fluid 26 is held, is near by the O ring 24. Thereby the magnetic fluid 26 can easily reach to the sliding face of the O ring 24 and suitably acts as the lubricant.

The form of the sealing groove 20 formed by the first inner protruded edge 19a and the second inner protruded edge 19b is not limited to the form shown in the first embodiment, and for example, the form thereof may be that of shown in FIG. 3(b) and FIG. 3(c). FIG. 3(b) and FIG. 3(c) are the enlarged cross section showing the modified example of the first magnetic pole member 18 shown in FIG. 3(a).

In the first magnetic pole member 40 shown in FIG. 3(b), the first inner protruded edge 39a has a form that is roughly symmetrical to the second inner protruded edge 39b. In the modified example shown in FIG. 3(b), the fluid holding projection 42 is formed at the edge portion of the first inner protruded edge 39a, and the edge portion 42a of the fluid holding extruded portion 42 is provided near by the O ring 24. Also, since the magnetic fluid 26 is held at the fluid holding projection portion 42, the magnetic fluid 26 is provided near by the O ring 24. Therefore, even when using the first magnetic pole member 40 shown in FIG. 3(b) to the sealing apparatus 3 according to the first embodiment, the magnetic fluid 26 can easily reach to the sliding face between the shaft 10 and the O ring 24 and can suitably act as the lubricant.

In the magnetic pole member 51 shown in FIG. 3(c), the first inner protruded edge 49a has a form that is roughly symmetrical to the second inner protruded edge 49b, and projects out towards the sealing groove 48. In the modified example shown in FIG. 3(c), the magnetic fluid 26 is held at the edge portion 50 of the first inner protruded edge 49a. In the modified example shown in FIG. 3(c), the first inner protruded edge 49a forming the sealing groove 48 projects out towards the sealing groove 48, and the sealing groove 48 has a dovetail groove form. Therefore, the edge portion 50 of the inner protruded edge 49a is provided near by the O ring 24. Also, since the magnetic fluid 26 is held at the edge portion 50 of the first inner protruded edge 49a, the magnetic fluid 26 is provided near by the O ring 24. Therefore, even when using the first magnetic pole member 51 shown in FIG. 3(c) to the sealing apparatus 3 according to the first embodiment, the magnetic fluid 26 can easily reach to the sliding face between the shaft 10 and the O ring 24 and can suitably act as the lubricant.

### Second Embodiment

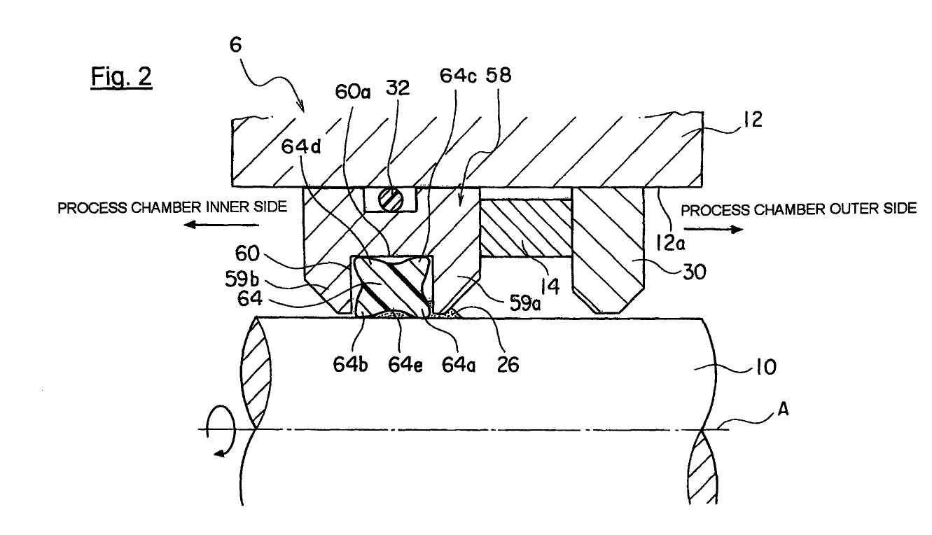

FIG. 2 is a cross section showing the sealing apparatus 6 according to the second embodiment of the present invention. In the sealing apparatus 6 according to the second embodiment, the form of the first magnetic pole member 58, and the form of a X ring 64 used as the sealing member has a different form from the first magnetic pole member 18 and the O ring 24 provided in the sealing apparatus 3 of the first embodiment. However, other parts are the same as the sealing apparatus 3 of the first embodiment and the same numbers as the first embodiment are labeled for the same member as the first embodiment.

The first magnetic pole member 58 comprises the first inner protruded edge 59a and the second inner protruded edge 59b projecting out towards the outer circumference 10a side of the shaft 10 from the inner circumference 12a side of the housing 12, as similar to the first magnetic pole member 18 according to the first embodiment. However, at the edge portion of the first protruded edge 59a, the fluid holding projection portion is not formed unlike the first inner protruded edge 19a of the first embodiment.

The first inner protruded edge 59a and the second inner protruded edge 59b have a form that is roughly symmetric to each other, and the sealing groove 60 comprising the opening at the shaft 10 side is formed between the first inner protruded edge 59a and the second inner protruded edge 59b. The cross section of the sealing groove 60 observed from the cross section passing through the axis A of the shaft has roughly a square form.

The X ring 64 comprises a first projection 64a, a second projection 64b, a third projection 64c, and a fourth projection 64d projecting towards each four corners of the square at the cross section of the sealing groove 60.

Among the corners of the square shape, the first projection 64a and the second projection 64b projects out towards the corners of the opening side of the sealing groove 60. Among the corners of the opening side of the sealing groove 60, the first projection 64a projects out towards the corner of the first inner protruded edge 59a side; and the second projection 64b projects out towards the corner of the second inner protruded edge 59b side.

Also, among the corners of the square form, the third projection 64c and the fourth projection 64d projects towards the corners of the base portion 60a side of the sealing groove 60. Furthermore, the first to fourth projections of the X-ring 64 are continuous along the circumferential direction of the X ring 64.

The third projection 64c and the fourth projection 64d contact with the base portion 60a of the sealing groove 60, and the X ring 64 and the sealing groove 60 are closely and continuously contacted in the circumferential direction. Also, the inner diameter of the X ring 64 is designed so that it has roughly the same diameter as that of the shaft 10, or slightly smaller than that of shaft 10. Therefore, when the shaft 10 rotates taking the axis A as the center, the first projection 64a and the second projection 64b of the X ring slides against the outer circumference 10a of the shaft 10. Thereby the X ring 64 according to the second embodiment can seal between the first magnetic pole member 58 and the shaft 10.

The magnetic fluid holding groove 64e is formed between the first projection 64a and the second projection 64b so that the magnetic fluid 26 can reach to the second projection 64b. That is, the fluid holding groove 64e is designed so that the magnetic fluid 26 can be lead from first projection 64a to the second projection 64b due to the surface tension of the fluid holding groove 64e and the outer circumference 10a of the shaft 10 opposing to the fluid holding groove 64e. Also, the fluid holding groove 64e can hold the magnetic fluid 26 between the fluid holding groove 64e and the outer circumference 10a of the shaft 10 opposing the fluid holding groove 64e.

When the shaft 10 rotates taking the axis A as the center, the magnetic fluid 26 is held near the edge portion of the first inner protruded edge 59a the most. The first projection 64a of the X ring 64 is provided near by the edge portion of the first inner protruded edge 59a; thus the magnetic fluid 26 can easily reach to the sliding face between the shaft 10 and the first projection 64a of the X ring 64, and can suitably act as the lubricant.

Also, since the fluid holding groove 64e is formed at the X ring 64, the magnetic fluid 26 can easily reach to the second projection 64b via the first projection 64a and the fluid holding groove 64e. That is, in the sealing apparatus 6 according to the second embodiment, the magnetic fluid 26 can easily reach to the both sliding faces formed between the outer circumference 10a of the shaft 10, and the first projection 64a and the second projection 64b. Therefore, the magnetic fluid 26 can suitably act as the lubricant at the sliding face between the X ring 64 and the shaft 10.

Note that, the magnetic fluid 26 may be held at the edge portion of the second inner protruded edge 59b in some case. The magnetic fluid 26 held near by the edge portion of the second inner protruded edge 59b can easily reach to the second projection 64b of the X ring 64. However, since the second inner protruded edge 59b has a longer distance from the magnet 14 than the first inner protruded edge 59a, the magnetic flux does not pass through as much as the first inner protruded edge 59a. Therefore, small amount of the magnetic fluid 26 is held at the edge portion of the second inner protruded edge 59b, thus in some cases, the magnetic fluid 26 held at the edge portion of the second inner protruded edge 59b may not be enough to sufficiently lubricate the sliding face between the second projection 64b and the outer circumference 10a of the shaft 10.

However, in the sealing apparatus 6 according to the second embodiment, as described in the above, the magnetic fluid 26 held near by the edge portion of the first inner protruded edge 59a can easily reach to the second projection 64b via the first projection 64a and the fluid holding groove 64e. Thus, the magnetic fluid 26 can suitably acts as the lubricant at the sliding face between the X ring 64 and the shaft 10.

### Third Embodiment

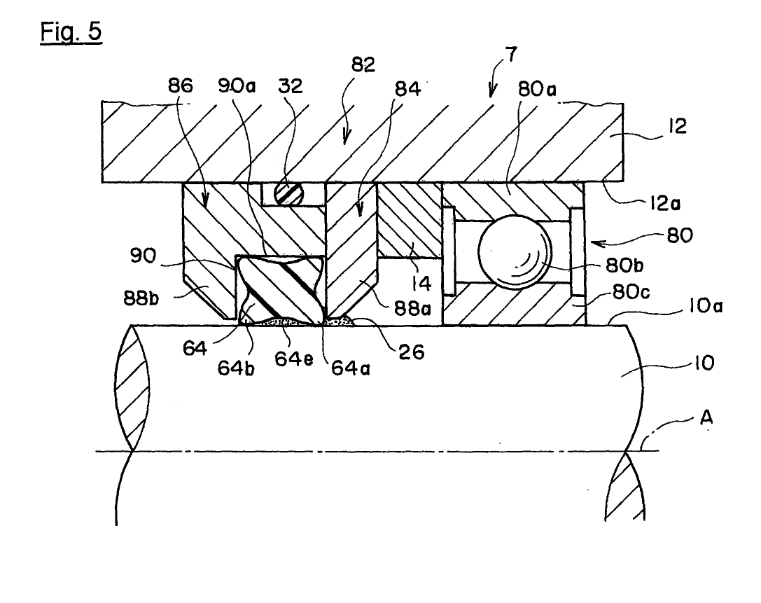

FIG. 5 is the cross section of the sealing apparatus 7 according to the third embodiment of the present invention. The sealing apparatus 7 according to the third embodiment differs from the sealing apparatus 6 according to the second embodiment since the second magnetic pole member is constituted by the ball bearing 80, and the first magnetic pole member 82 is constituted by the first ring portion 84 and the second ring portion 86. However, other parts are same as the sealing apparatus 6 of the second embodiment and the same numbers as the second embodiment are labeled for the same member as the second embodiment.

As shown in FIG. 5, in the sealing apparatus 7, the ring form magnet 14 is provided between the first magnetic pole member 82 and the ball bearing 80 so that the both ends of the ring magnet 14 is sandwiched in the axis A direction. The ball bearing 80 is provided so that it contacts with the edge portion of the magnet 14 at the process chamber outer side.

The ball bearing 80 comprises an outer circumference ring 80a equipped to the inner circumference 12a of the housing, an inner circumference ring 80c equipped to the shaft 10, and a plurality of balls 80b held by sandwiched between the outer circumference ring 80a and the inner circumference ring 80c in the radial direction.

The inner circumference ring 80c is provided by fixing to the shaft 10, and when the shaft 10 rotate around the axis A, it rotates together with the shaft 10. Plurality of balls 80b is provided along the outer circumference direction of the shaft 10. The inner circumference ring 80c fixed to the shaft 10 can make a relative rotation with a low friction state against the outer circumference ring 80a fixed to the housing by a rotation of the ball 80b.

The outer circumference ring 80a, the ball 80b, and the inner circumference ring 80c are formed by the magnetic material and suitably act as the magnetism transferring member of the magnet 14. That is, the ball bearing 80 function as the second magnetic pole member 30 of the sealing apparatus 3 and 6 of the first and the second embodiment, and the magnetic force generated by the magnet 14 is transferred to the magnetic fluid 26 via the ball bearing 80 and the shaft 10.

The first magnetic pole member 82 comprises the first ring portion 84 provided at the process chamber outer side, and the second ring portion 86 provided at the process chamber inner side with respect to the first ring portion 84. The first ring portion 84 is provided so that it contacts with the end portion of the magnet 14 at the process chamber inner side. The first ring portion 84 has roughly an I shaped cross section when observed from the cross section passing through the axis A of the shat 10.

The second ring portion 86 has roughly an I shaped cross section when observed from the cross section passing through the axis A of the shaft 10. The second ring portion 86 is provided so that it contacts with the end portion of the first ring portion 84 at the process chamber inner side.

In the sealing apparatus 7 according to the third embodiment, the first magnetic pole member 82 is constituted by the two members that is the first ring portion 84 and the second ring portion 86. That is, the sealing groove 90 wherein the X ring is placed in is formed by combining the first ring portion 84 and the second ring portion 86. The first inner protruded edge 88a which is a wall of the sealing groove 90 at the process chamber outer side is constituted by a part of the first ring portion 84. Also the second inner protruded edge 88b which is a wall of the sealing groove 90 at the process chamber inner side and the base portion 90a of the sealing groove 90 are constituted by the second ring portion 86.

The X ring 64 placed in the sealing groove 90 is same as the X ring 64 comprised in the sealing apparatus 6 according to the second embodiment. The first projection 64a and the second projection 64b of the X ring 64 slides against the outer circumference 10a of the shaft 10 and seals between the first magnetic pole member 82 and the shaft 10.

As the sealing apparatus 6 according to the second embodiment, in the sealing apparatus 7 according to the present embodiment, the magnetic fluid 26 held near by the first inner protruded edge 88a easily reaches to the first projection 64a near by the edge portion of the first inner protruded edge 88a; and can suitably act as the lubricant. Also, the fluid holding projection groove 64e is formed at the X ring 64, hence the magnetic fluid 26 can easily reach to the second projection 64b via the first projection 64a and the fluid holding groove 64e.

Further, the sealing apparatus 7 according to the present embodiment comprises the ball bearing 80, and the ball bearing 80 also function as the magnetism transferring member for transferring the magnetism of the magnet 14. Therefore, the sealing apparatus 7 can accurately bear the shaft 10. Further, the sealing apparatus 7 also function as the magnetism transferring member for transferring the magnetism of the magnet 14, thus there is no need to provide the other second magnetic pole member, and hence it is suited for downsizing. Also, the sealing apparatus 7 has no need to provide the other bearing to bear the shaft 10 at the process chamber inner side or the process chamber outer side of the sealing apparatus 7, alternatively the other bearing provided can be simplified. Therefore, also from this point of view, the sealing apparatus 7 is suitable for downsizing.

The sealing apparatus 7 according to the present embodiment can improve the holding ability of the magnetic fluid 26 by having a structure wherein the magnetic force line passes through the ball bearing 80 thereby the magnetic force is focused to between the first inner protruded edge 88a at the first magnetic pole member 82 and the shaft 10. This is because the sealing apparatus 7 can transfer the magnetic force generated in the magnet 14 to the magnetic fluid 26 by the magnetism circuit formed by connecting the parts using the magnetic material.

Further, in the sealing apparatus 7 according to the present embodiment, the first magnetic pole member 82 is formed by the two members constituted by the first ring portion 84 and the second ring portion 86. Moreover, the X ring 64 is provided between the first ring portion 84 and the second ring portion 86 so that the both ends of the axis A direction are sandwiched. Thereby, in the sealing apparatus 7 according to the present embodiment, the X ring 64 can be easily replaced.

Note that, in the sealing apparatus 7 according to the present embodiment, the base portion 90a of the sealing groove 90 is constituted by the second ring portion 86. However, the constitution of the sealing groove 90 is not limited to that of shown in FIG. 5, and for example, the base portion 90a of the sealing groove 90 may be constituted by the first ring portion. That is, as the sealing apparatus according to the modified example of the third embodiment, the first ring portion contacting to the magnet 14 has a cross section of roughly a T shape, and the second ring portion contacting to the first ring portion has a cross section of roughly an I shape may be mentioned. The sealing apparatus according to such modified example has same effect as the sealing apparatus 7 shown in FIG. 5.

Also, as the sealing apparatus according to the other modified example of the third embodiment, a constitution of the first ring portion 84 and the second ring portion 86 shown in FIG. 5 being one member, not a separate member, may be mentioned. The sealing apparatus wherein the first ring portion 84 and the second ring portion 86 shown in FIG. 5 are made in one body also has the same effect as the sealing apparatus 7 according to the third embodiment in regards with the holding ability of the magnetic fluid 26.

### Example 1

In the following, the result of the sliding lifetime evaluation of the sealing member performed by using the sealing apparatus 3 and 6 of the first embodiment shown in FIG. 1 and the second embodiment shown in FIG. 2 are shown as the examples of the present invention; and the result of the sliding lifetime evaluation performed by using the sealing apparatus according to the reference example are shown.

In the example 1, the sliding lifetime evaluation of the O ring 24 as the sealing member was performed by using the sealing apparatus 3 according to the first embodiment shown in FIG. 1. As for the magnetic fluid 26, fluorine based magnetic fluid was used. The rotation speed of the shaft 10 during the sliding lifetime evaluation according to the example was performed under the condition so that the moving speed of the outer circumference 10a of the shaft 10 becomes 0.4 to 0.6 m/s.

Also, the sliding lifetime evaluation according to the example was performed at the state wherein the inside of the process chamber was 10−5 to 10−4 Pa, and the outside of the process chamber was at atmospheric pressure. Further, the sliding lifetime was defined as the distance of the relative movement of the O ring 24 against the outer circumference 10a of the shaft 10, from the beginning of the evaluation until the pressure inside the process chamber exhibited continuous rise or until the rotation speed of the shaft 10 declined. Note that, the decline in the rotation speed of the shat 10 occur when the sliding resistance rises due to the abrasion or so of the O ring 24 and thereby causing to enlarge the sliding resistance than the driving torque of the shaft 10 by the motor or so. The results are shown in Table 1.

### Example 2

In the example 2, the sliding lifetime evaluation of the X ring 64 as the sealing member was performed by using the sealing apparatus 6 according to the second embodiment shown in FIG. 2. As for the magnetic fluid 26, the fluorine based magnetic fluid was used as the example 1. Also, in the example 2, rest of the conditions such as the rotation speed of the shaft or so was the same as the example 1. The results are shown in Table 1.

### Reference Example 1

In the reference example 1, the sliding lifetime evaluation of the O ring 24 was performed as same as the example 1, except that the magnetic fluid 26 was not used and fluorine based grease Y was coated to the O ring 24. The results are shown in Table 1.

### Reference Example 2

In the reference example 2, the sliding lifetime evaluation of the O ring 24 was performed as same as the example 1, except that the magnetic fluid 26 was not used and fluorine based grease Z was coated to the O ring 24. The results are shown in Table 1.

### Reference Example 3

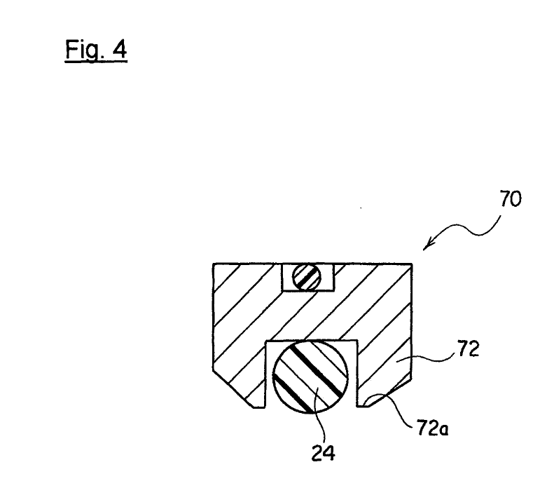

In the reference example 3, the sliding lifetime evaluation of the O ring 24 was performed as same as the example 1, except for using the first magnetic pole member 70 shown in FIG. 4 instead of the first magnetic pole member 18 shown in FIG. 1. That is, the sliding lifetime evaluation according to the reference example 3 was performed by using the sealing apparatus comprising the O ring 24 having roughly a circular cross section, and the first magnetic pole member 70 in which the fluid holding projection portion 22 was not formed thereto. The results are shown in Table 1.

TABLE 1

| | Sealing | | Fluid holding | Sliding lifetime |
|---|---|---|---|---|
| | member | Lubricant | projection portion | (km) |
| Example 1 | O ring | Fluorine based | Have | 1545 |
| | | magnetic fluid | | |
| Example 2 | X ring | Fluorine based | None | 4200 |
| | | magnetic fluid | | |
| Reference | O ring | Fluorine based | Have | 88 |
| example 1 | | grease Y | | |
| Reference | O ring | Fluorine based | Have | 140 |
| example 2 | | grease Z | | |
| Reference | O ring | Fluorine based | None | 5 |
| example 3 | | magnetic fluid | | |

### TOTAL EVALUATION

In the example 1, the O ring 24 had 10 to 300 times more of the sliding lifetime compared with each reference examples. In the sealing apparatus 3 used in the example 1, the fluid holding portion 22 shown in FIG. 1 projects out towards the O ring 24 and the shaft 10. Hence, the edge portion of the fluid holding projection portion 22 holding the magnetic fluid the most is provided near by the O ring 24. Therefore, the magnetic fluid 26 can easily reach to the sliding face between the shaft 10 and the O ring 24 via the O ring 24, and thus it is speculated that the magnetic fluid 26 has suitably acted as the lubricant at the sliding face.

The X ring 64 used as the sealing member in the example 2 had 30 to 840 times more of the sliding lifetime compared with each reference examples. In the sealing apparatus 6 used in the example 2, the edge portion of the first inner protruded edge 59a shown in FIG. 2 is near by the first projection 64a of the X ring 64. Thus, the magnetic fluid 26 and the sealing member are more near by than using the O ring 24. Therefore, the magnetic fluid 26 can easily reach to the sliding face of the first projection 64a of the X ring 64, and it is speculated that the magnetic fluid 26 suitably acted as the lubricant at the sliding face. Also, the magnetic fluid 26 easily reach to the second projection 64b via the first projection 64a of the X ring 64 and the fluid holding projection groove 64e of the X ring 64, and thus it is speculated that the magnetic fluid 26 has suitably acted as the lubricant at the sliding face between the X ring 64 and the shaft 10.

Also, the viscosity of the magnetic fluid 26 used in the example 1 and example 2 are lower than the viscosity of the greases used in the reference examples 1 and 2; however, the magnetic fluid 26 is held at the fluid holding projection 22 by the magnetic force, thus it is held at the sliding face between the sealing member (the O ring 24 or the X ring 64) and the shaft 10. As such, the magnetic fluid 26 has low viscosity and can easily reach to the sliding face, thus the magnetic fluid as a whole is maintained in a more nonbiased condition. Therefore, the magnetic fluid 26 is prevented from being partially damaged, and thus it is speculated that the magnetic fluid 26 in the example has suitably acted as the lubricant.

In the reference example 1 and the reference example 2 wherein the greases were used as the lubricant, the O ring 24 only had 1/11 to 1/18 of the sliding lifetime compared to the example 1. The greases Y and Z used in the reference example 1 and the reference example 2 are the grease used generally in the prior arts. The grease used generally in the prior arts has higher viscosity than the magnetic fluid 26 used in the example 1 and the example 2. Thus, in the reference example 1 and the reference example 2, when the grease at the sliding face is deteriorated, the deteriorated grease cannot be placed with the surrounding grease, hence it is speculated that the sliding lifetime of the O ring 24 was shortened.

The reference example 3 which used the sealing apparatus comprising the first magnetic pole member 70 (FIG. 4) in which the fluid holding projection portion 22 was not formed only had 1/300 of the sliding lifetime compared with the example 1, although the magnetic fluid 26 was used as the lubricant. In the reference example 3, the magnetic fluid 26 can be held at the edge portion 72a of the first inner protruded edge 72 shown in FIG. 4. However, since the distance between the edge portion 72a of the first inner protruded edge 72 and the O ring 24 are long, the magnetic fluid 26 does not sufficiently reach to the sliding face between the O ring 24 and the shaft 10, and thus it is speculated that the magnetic fluid 26 couldn't sufficiently act as the lubricant.

1. A magnetic fluid sealing apparatus transferring a predetermined mechanical motion to inside of a process chamber maintained at a predetermined environment from outside of the process chamber while maintaining the environment of the process chamber; wherein the sealing apparatus comprises,
a shaft transferring the predetermined mechanical motion to the process chamber,
a housing through which the shaft penetrates,
a magnetic force generating means generating a magnetic force around the shaft by provided between the housing and the shaft,
a magnetism transferring member having a pair of inner protruded edges forming a sealing groove surrounding the shaft by projecting toward the shaft from the housing, and transferring the magnetic force generated from the magnetic force generating means by provided adjacent to the magnetic force generating means,
a sealing member stored in the sealing grooves while at least part of the sealing member is projecting out towards the shaft and sliding against the outer face of the shaft, and
a magnetic fluid held between the shaft and the magnetism transferring member due to the magnetic force generated by the magnetic force generating means; wherein
a fluid holding projection portion projecting out towards the shaft and the sealing member is formed at an end portion near by the shaft of a first inner protruded edge, and said first inner protruded edge is one of said pair of the inner protruded edges adjacent to the magnetic force generating means.

2. A magnetic fluid sealing apparatus transferring a predetermined mechanical motion to inside of a process chamber maintained at a predetermined environment from outside of the process chamber while maintaining the environment of the process chamber; wherein the sealing apparatus comprises,
a shaft transferring the predetermined mechanical motion to the process chamber,
a housing through which the shaft penetrates,
a magnetic force generating means generating a magnetic force around the shaft by provided between the housing and the shaft,
a magnetism transferring member having a pair of inner protruded edges forming a sealing groove surrounding the shaft by projecting toward the shaft from the housing and, transferring the magnetic force generated from the magnetic force generating means by provided adjacent to the magnetic force generating means,
a sealing member stored in the sealing grooves while at least part of the sealing member is projecting out towards the shaft and sliding against the outer face of the shaft, and
a magnetic fluid held between the shaft and the magnetism transferring member due to the magnetic force generated by the magnetic force generating means; wherein
the sealing grooves having a dovetail groove form.

3. A magnetic fluid sealing apparatus transferring a predetermined mechanical motion to inside of a process chamber maintained at a predetermined environment from outside of the process chamber while maintaining the environment of the process chamber; wherein the sealing apparatus comprises,
a shaft transferring the predetermined mechanical motion to the process chamber,
a housing through which the shaft penetrates,
a magnetic force generating means generating a magnetic force around the shaft by provided between the housing and the shaft,
a magnetism transferring member having a pair of inner protruded edges forming a sealing groove surrounding the shaft by projecting toward the shaft from the housing, and transferring the magnetic force generated from the magnetic force generating means by provided adjacent to the magnetic force generating means,
a sealing member stored in the sealing grooves while at least part of the sealing member is projecting out towards the shaft and sliding against the outer face of the shaft, and
a magnetic fluid held between the shaft and the magnetism transferring member due to the magnetic force generated by the magnetic force generating means; wherein
a cross section of the sealing grooves observed from the cross section passing through a center axis of the shaft has roughly a square form,
the sealing member comprises four projection portions projecting out towards each of corners of the sealing grooves having roughly a square form, and
a fluid holding groove configured to hold the magnetic fluid is formed between two projection portions projecting out towards the shaft side among the projection portions.

4. The sealing apparatus as set forth in claim 1 further comprising a second magnetism transferring member provided to sandwich the magnetic force generating means with respect to the magnetism transferring member to transfer the magnetism generated by the magnetic force generating means.

5. The sealing apparatus as set forth in claim 2 further comprising a second magnetism transferring member provided to sandwich the magnetic force generating means with respect to the magnetism transferring member to transfer the magnetism generated by the magnetic force generating means.

6. The sealing apparatus as set forth in claim 3 further comprising a second magnetism transferring member provided to sandwich the magnetic force generating means with respect to the magnetism transferring member to transfer the magnetism generated by the magnetic force generating means.
